(19) United States
(12) Patent Application Publication
(10) Pub. No.: US 2004/0102973 A1
(43) Pub. Date: May 27, 2004

(54) Process, apparatus, and system for phonetic dictation and instruction

(76) Inventor: Christopher B. Lott, Smithfield, UT (US)

Correspondence Address: Brian C. Kunzler, Suite 425, 10 West 100 South, Salt Lake City, UT, 84101, US

(21) Appl. No.: 10/385,937

(22) Filed: Mar. 11, 2003

Related U.S. Application Data
(63) Continuation-in-part of application No. 60/427,997, filed on Nov. 21, 2002.

(51) Int. Cl. G10L 15/00

(52) U.S. Cl. 704/254

(57) ABSTRACT

A process, apparatus, and system are provided for phonetic dictation and instruction, including displaying phonemic symbols such as the International Phonetic Association (IPA) symbols, selecting one of the phonemic symbols, and communicating an audible representation of the phonemic segment associated with the selected phonemic symbol. The process, apparatus, and system may also provide for communicating a visual representation of a human speaker articulating the phonemic segment, either individually or incorporated in a word or phrase. The process, apparatus, and system may also provide for aggregating a plurality of phonemic symbols and communicating an audible representation of the aggregated phonemic segments associated with the selected phonemic symbols.

### BACKGROUND OF THE INVENTION

1. Related Applications

This application is a continuation-in-part of and claims priority to U.S. patent application Ser. No. 60/427,997, filed on Nov. 21, 2002, and entitled “Process, Apparatus, and System for Phonetic Dictation and Instruction,” which is incorporated herein by reference.

2. Field of the Invention

The invention relates to phonetic dictation and more particularly to an electronic device and system for audibly and visually dictating individual and aggregated phonemic segments of speech to a user.

3. Description of Related Art

There is an ever-increasing demand in the modern world to communicate in multiple languages in the course of international business and travel. With the international availability of the Internet and the tremendous growth in telecommunications capabilities, individuals from anywhere in the world are potentially capable of communicating with other individuals, businesses, and governments with great technological ease. Additionally, the availability and speed of international travel provide means for international travel for business and pleasure purposes.

In the course of such international travel and communications, it is vitally important that one party be able to effectively communicate with another party. In the most fundamental form, whether aided or not by the available technology, the two parties are most likely to communicate verbally in one or more languages. One party may be knowledgeable and experienced in the language of the other, allowing the two parties to communicate at some level. Under distinct circumstances, it may happen that neither party is able to communicate with the other either because of a lack of knowledge of the other's language or because of some mistaken or ineffective communication.

Within the field of verbal communication, pronunciation is fundamentally important. Many languages employ multiple symbols and letters to form words and phrases that have developed an understanding or definition. However, within a single language, there may exist many variations among the combinations of letters and symbols that employ the same or very similar sounds, or phonemes. Similarly, slight variations of symbols and letters may employ very distinct phonemes. A phoneme is a basic and distinct unit of sound employed in speech that is used alone or in combination with other phonemes to produce morphemes, words, sentences, and so forth. A morpheme is a minimal grammatical unit of language.

Over the years, teaching pronunciation of languages has long been available in a variety of forms and techniques. It may be thought that initially verbal languages and their pronunciation might have been taught strictly in person as in a teacher-student relationship. A teacher may have taught words and phrases to a student by example and repetition, focusing on the sound of the repeated expressions. Additionally, a teacher may have provided examples of mouth positions and such in order to help a student more accurately form the proper sounds.

More recently, a variety of methods have been suggested and used to teach pronunciation. These methods include audio and video recordings of language samples, photographic depictions of mouth positions, and voice synthesizers operable through selection of alphabetic letters and other symbols. Many of the available methods and devices, however, require that a user acquire knowledge of specialized or proprietary symbol schemes, keypad layouts, writing techniques, and other concepts and systems.

What is needed is a process, apparatus, and system that allows a user to take advantage of a standard, internationally accepted set of symbols, such as the standard symbols adopted by the International Phonetic Association (IPA), in order to teach and learn the pronunciation of words and phrases in an unfamiliar language. For example, a person learning the German language, or a dialect thereof, might use such a process, apparatus, or system by referencing an English-German dictionary, locating the corresponding IPA symbols, and selecting corresponding symbols on the apparatus for sample pronunciation. The IPA symbols in a German dictionary are similar to the American Heritage Dictionary (AHD) symbols and pronunciation key available in and English dictionary.

Beneficially, the proposed process, apparatus, and system would communicate sample audio and video pronunciation representations for each of the phonemes designated by the IPA symbols. Additionally, the process, apparatus, and system would serve to audibly dictate one or more sounds associated with specific IPA symbols.

### BRIEF SUMMARY OF THE INVENTION

The present invention has been developed in response to the present state of the art, and in particular, in response to the problems and needs in the art that have not yet been fully solved by currently available phonetic dictation and instruction devices and methods. Accordingly, the present invention has been developed to provide a process, apparatus, and system for phonetic dictation and instruction that overcome many or all of the above-discussed shortcomings in the art.

The apparatus for phonetic dictation and instruction is provided with a logic unit containing a plurality of modules configured to carry out the individual steps of phonetic dictation and instruction. These modules in the described embodiments include a phonemic selection module, an audio communication module, a phonemic aggregation module, a video communication module, a speaker demo module, a point of articulation module, a variable display module, a phonemic symbol display module, a sample term display module, and a technical term display module.

In one embodiment, the apparatus for phonetic dictation and instruction is configured to display, through the phonemic symbol display module, a set of phonemic symbols, corresponding to a plurality of International Phonetic Association (IPA) symbols, from which a user may select one of the symbols. Upon selection of a phonemic symbol, the apparatus is configured to communicate an audible representation of the phonemic segment corresponding to the selected phonemic symbol.

The apparatus may display the phonemic symbols to a user in a keypad format. The keypad may be a set of physical buttons in one embodiment, or in electronic format, digitally displayed on a computer screen. The set of symbols displayed includes IPA symbols that are used in many languages, especially for pronunciation of words and phrases. The set of symbols may also include other symbols that represent related sounds, movements, or pronunciations that are related to the phonemic segments represented by the IPA symbols.

The apparatus may also display IPA and other symbols in response to a user selection. For example, the apparatus may be configured to display an enlarged or highlighted phonemic symbol so as to show that the enlarged or highlighted symbol has been selected. The apparatus may also show other symbols, such as alphanumeric characters in the form of words and phrases. These words and phrases may be shown in response to selection of phonemic symbol. They may also be shown as exemplary of words incorporating the phonemic segments into their pronunciation, as through the sample term display module. The words may also be technical linguistic terms that are descriptive of the articulation of the selected phonemic segment. There may also be other instances in which the phonemic symbol display module displays phonemic and other symbols in anticipation of a user selection or in response to a user selection.

The apparatus for phonetic dictation and instruction is configured to allow a user to select, as through the phonemic selection module, a phonemic segment corresponding to the displayed phonemic symbols. In one embodiment, a user may select a phonemic segment by depressing a physical key or button identified by a phonemic symbol. In another embodiment, the user may use an electronic interface, such as a touch screen or a computer screen and mouse, on which the phonemic symbols are displayed. The user may select a phonemic segment from the displayed phonemic symbols using a stylus, a mouse, or another device suitable for selecting an icon or symbol displayed on the electronic screen. In a further embodiment, the user may select a phonemic segment through audible means, such as voice recognition and so forth.

The apparatus for phonetic dictation and instruction is further configured to communicate a representation of a selected phonemic segment in audible format to a user, as through the audio communication module. In one embodiment, the audible representation may be a digitally processed recording communicated through an electronic speaker. In an alternate embodiment, an electronically generated representation may be communicated to the user.

The apparatus may be further configured to communicate a visual representation of a human speaker to a user, as through the video communication module. The visual representation may depict a frontal view of a speaker's mouth as the represented human speaker articulates the selected phonemic symbol, as through the speaker demo module. The visual representation may also depict a sectional view of the mouth and nasal cavity, including placement of the tongue, during speaker articulation of the phonemic segment, as through the point of articulation module.

The apparatus for phonetic dictation and instruction may be further configured to execute display, selection, and communication functions relating to an aggregated set of phonemic segments corresponding to a set of phonemic symbols, as through the phonemic aggregation module. In other words, a user may select a plurality of phonemic segments, place them in a desired order, and invoke an audible representation of the aggregated phonemic segments. In this way, a user may select phonemic symbols corresponding to the pronunciation of a word or phrase and then hear the audible representation corresponding to the word or phrase constructed.

A process of the present invention is also presented for phonetic dictation and instruction. The method in disclosed embodiments substantially includes the steps necessary to carry out the functions presented above with respect to the operation of the described apparatus.

In particular, the process for phonetic dictation and instruction includes displaying a set of phonemic symbols, selecting one of the displayed symbols, and communicating an audible representation of the selected phonemic symbol to a user. The process may also include communicating a visual representation of a human speaker to a user, as well as communicating an audible representation of a set of aggregated phonemic segments to a user.

The process displays a set of phonemic symbols through, for example, the phonemic symbol display module. As described above, these symbols may be permanently displayed through physical printing or may be electronically generated. While the symbols are displayed, a user selects one of the symbols, which may invoke the display of additional symbols or an alternative display of the same symbol. The process then communicates the audible representation of the corresponding phonemic segment to the user. To do so, the process may access an electronic sample file that may be communicated to the user via an electrical speaker. When multiple phonemic symbols are aggregated and arranged by the user, the process may access multiple sample files for sequential playback, or alternately may digitally concatenate the files prior to playback. The process may also access stored video files corresponding to the selected phonemic symbols in order to communicate a visual representation of a human speaker articulating the phonemic segment.

These features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a representative phonetic dictation apparatus in accordance with the present invention;

FIG. 2 is a schematic block diagram illustrating one embodiment of a representative user interface of a phonetic dictation apparatus in accordance with the present invention;

FIG. 3 is a schematic block diagram illustrating one embodiment of a representative portable phonetic dictation apparatus in accordance with the present invention;

FIG. 4 is a schematic flow chart diagram illustrating one embodiment of a representative phonetic dictation process for program functionality in accordance with the present invention; and

FIG. 5 is a schematic flow chart diagram illustrating one embodiment of a representative phonetic dictation process for program use in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

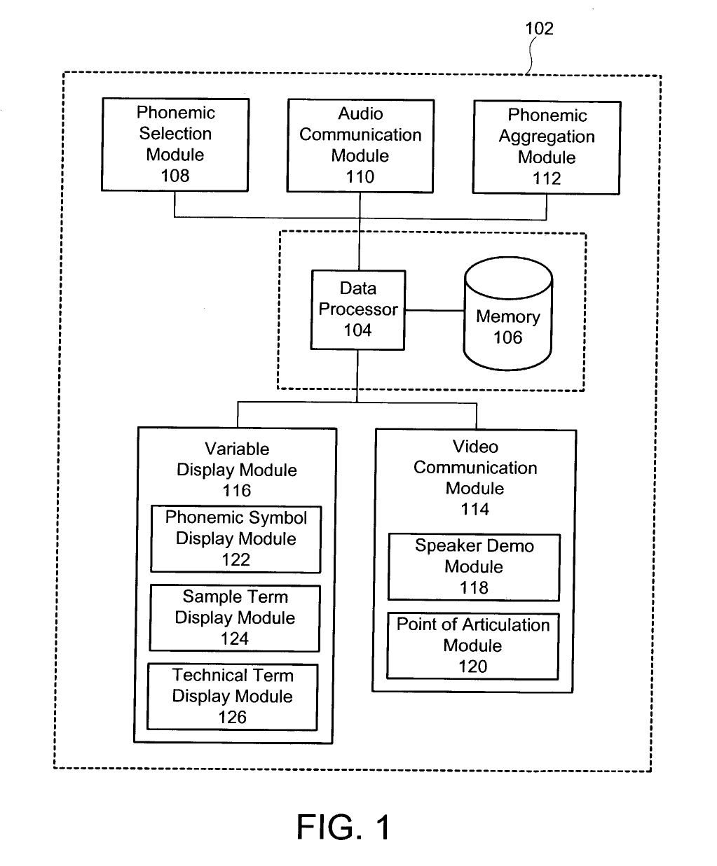

FIG. 1 depicts one embodiment of an apparatus 102 for phonetic dictation and instruction. The apparatus includes a data processor 104 and an electronic data memory 106. The data processor 104 is configured to transmit electronic signals to the memory 106 and among the other modules within the apparatus 102. The memory 106 is configured to store electronic instructions and computer readable code and may contain the operating instructions for the apparatus 102. In one embodiment, the data processor 104 and electronic data memory 106 may be physically contained within the apparatus 102. In an alternate embodiment, the data processor 104 and electronic data memory 106 may be remotely connected to the remaining modules of the apparatus via a wired or wireless data channel.

The depicted apparatus 102 also includes a phonemic selection module 108, an audio communication module 110, a phonemic aggregation module 112, a video communication module 114, and a variable display module 116.

The phonemic selection module 108 is configured to allow a user to select, through one or more methods described below, a phonemic segment that may be audibly or visually communicated to a user via the audio communication module 110, the video communication module 114, or the variable display module 116.

The audio communication module 110 is configured, as described above, to communicate an audible representation of the selected phonemic segment selected via the phonemic selection module 108. In order to communicate the phonemic segment to the user, the audio communication module 108 may access a data file in the memory 106 containing a digital representation of the phonemic segment. The data may then be converted through processes commonly known in the art to an audible signal through, for example, an internal or external electrical speaker.

The phonemic aggregation module 112 is configured to allow a user to aggregate a plurality of phonemic segments in order to produce and communicate a representation of the combined articulation of the plurality of phonemic segments. The user may select a series of phonemic segments via the phonemic selection module 108 and designate a given order for the selected phonemic segments via the phonemic aggregation module 112. Upon designating such an order for the plurality of phonemic segments, the apparatus 102 may employ the audio communication module 110, the video communication module 114, or the variable display module 116 in order to communicate a representation of the articulation of the combined phonemic segments to a user.

The depicted video communication module 114 includes a speaker demo module 118 and a point of articulation module 120. The speaker demo module 118 may be configured to communicate a visual representation of a human speaker articulating the phonemic segment selected via the phonemic selection module 108. The speaker representation may be viewed by a user in order to observe a sample articulation of the phonemic segment. The phonemic segment may be combined with other phonemic segments, such as within a word or phrase, or may be articulated independently.

The human speaker may be a native or non-native speaker of a specified language and may be portrayed to the user through a digital video recording, in one embodiment. In another embodiment, the speaker may be a graphically animated representation of a human speaker. In either case, or in alternative scenarios, the speaker demo module 118 may communicate a depiction of a mouth alone or may include additional facial and body gestures.

The point of articulation module 120 may be configured to communicate a representation of an anatomically correct, cross-sectional view of the mouth, nasal cavity, and throat. The depicted view may be a digital illustration of the area described or some other representation capable of showing the placement of the tongue within the mouth for articulation of the selected phonemic segment. The point of articulation module 120 may also be configured to animate the represented view of the mouth so as to show the movement of the tongue, teeth, and lips during articulation of the phonemic segment. In a further embodiment, the point of articulation module 120 may indicate certain points of contact or other movement of particular relationship to the articulated phonemic segment, such as where the tip of the tongue touches the upper lips or when the glottis is open or closed.

The video communication module 114 may be further configured to communicate the speaker demo video and the point of articulation animation to the user in a synchronous or asynchronous fashion. Additionally, the video communication module 114 may allow a user to control the start time, stop time, speed, direction, or other characteristic of the communication of the visual representations.

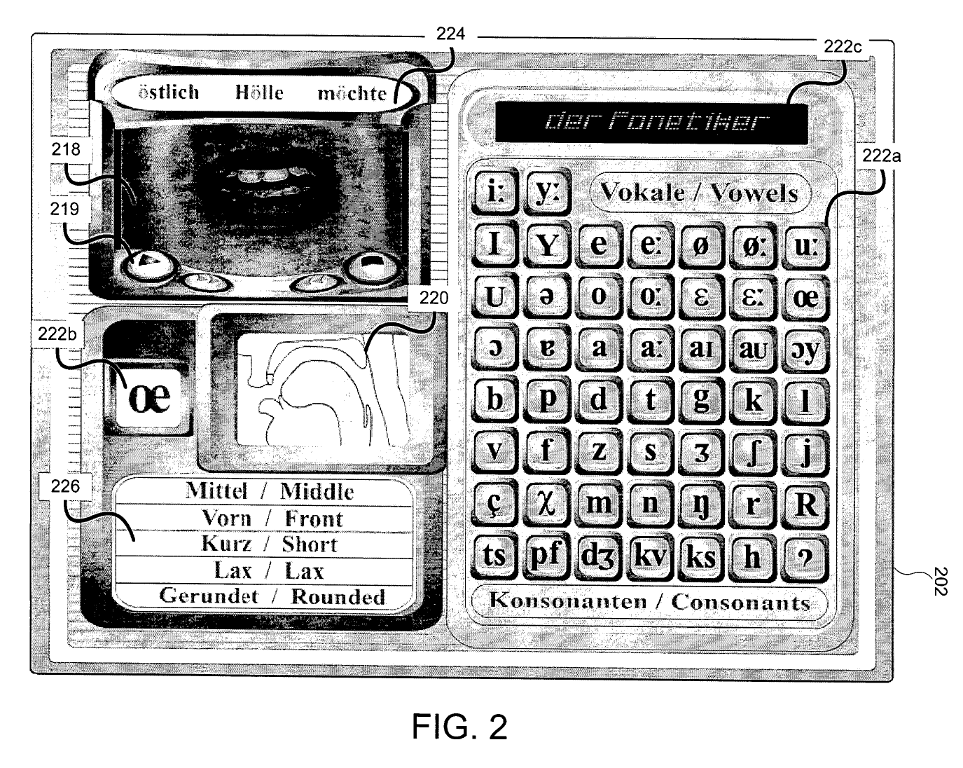

The variable display module 116 illustrated includes a phonemic symbol display module 122, a sample term display module 124, and a technical term display module 126. Each of these display modules 122, 124, 126 is configured to display distinct information to a user and may be displayed within an individual and distinct area of the apparatus 102. Alternately, the information from one or more of these display modules 122, 124, 126 may be combined in a single display, such as an LCD screen or other display, and shown within the same area of the display. This distinction will be further illustrated in the description of FIG. 2.

More specifically, the phonemic symbol display module 122 is configured to display a set of phonemic symbols, such as the symbols adopted by the International Phonetic Association (IPA). In addition to the IPA symbols, other symbols may be displayed to represent articulation functions, such as a glottal stop. The IPA symbols and other phonemic symbols each correspond to a phoneme that describes a basic unit of speech sound. As generally employed in human speech, phonemes are aggregated and articulated to form morphemes, words, phrases, and sentences. Within the apparatus 102, each phonemic symbol displayed may have a digital identifier that can be used as an index to access data associated with the phonemic symbol, such as pointers to video and audio files, sample text, technical terms, and so forth.

In a further embodiment, the phonemic symbol display module 122 may prominently display the selected phonemic symbol in addition to displaying the set of phonemic symbols. The prominently displayed phonemic symbol may be enlarged or highlighted by an appropriate means so as to clearly indicate which phonemic symbol will be or is selected.

The sample term display module 124 is configured to display one or more sample terms that employ the selected phonemic segment. Articulation of the selected phonemic segment within the sample term may occur at the beginning or end of a term or may occur within the middle of the term. Several sample terms may be displayed to portray diversity of use of the phonemic segment, in one embodiment. In an alternate embodiment, the terms may be similar in format in order to emphasize a particular employment of the phonemic symbol. Also, the sample terms displayed may be represented in alternate textual formats, for example, including phonetic symbols, a user language, or another language. The sample terms displayed may include some of the same terms that are articulated via the audio and video communication modules 110, 114.

The technical term display module 126 is similar to the sample term display module 124. The technical term display module 126 is configured to display one or more terms that describe the articulation of the selected phonemic segment. For example, for a given phonemic segment, the technical term display module 126 may display such terms as “middle,” “short,” and “lax” that describe particular aspects of the articulation of the given phonemic segment. The technical terms displayed may also be communicated, in one embodiment, to a user via the audio and video communication modules 110, 114.

FIG. 2 illustrates one embodiment of an apparatus 202 for phonetic dictation and instruction given by way of example of the apparatus 102 of FIG. 1. In particular, FIG. 2 depicts the visual display of one embodiment of the apparatus 102. The apparatus 202 shown is configured for use in both the English and German languages.

The depicted embodiment includes a speaker demo module 218 and a point of articulation module 220. The speaker demo module 218 illustrated communicates a video representation of a native human speaker of a given language. The visual representation may be synchronously communicated with an audible representation communicated via the audio communication module 110. Additionally, the depicted speaker demo module 218 includes a series of user interface buttons 219, such as “play,” “stop,” “frame forward,” and “frame backward,” that allow the user to determine the characteristics of the visual representation. Other controls may be included to provide additional functionality and administration of the video communication.

The point of articulation module 220 shown communicates a representation of a sectional view of an anatomically correct mouth, tongue, throat, etc. The point of articulation module 220 may communicate, in one embodiment, a still, digital graphic. In another embodiment, the point of articulation module 220 may communicate an animated representation that may or may not be synchronized with either the speaker demo representation communicated via the speaker demo module 218 or the audible representation communicated by the audio communication module 110.

The apparatus 202 depicted also includes a phonemic symbol display module 222, a sample term display module 224, and a technical term display module 226. The phonemic display module 222 illustrated includes three separate and distinct display areas 222a, 222b, 222c. The first display area 222a displays a set of phonemic symbols from which a user may make a selection. In the depicted embodiment, the phonemic symbols are arranged in two ways. First, the symbols are divided (top and bottom) to distinguish between vowel (top four rows) and consonant (bottom four rows) phonemes. On another level, the groups of vowel and consonant phonemic symbols are each spatially arranged with respect to each other (top, bottom, middle, and front to back from left to right) to indicate generally the location within the mouth cavity at which the articulation occurs.

In the illustrated embodiment, the second display area 222b displays a selected phonemic symbol that is chosen from the set of phonemic symbols displayed in area 222a. For example, the selected phonemic symbol shown is “œ.” Similarly, the third display area 222c may display one or more selected phonemic symbols selected from the set displayed in area 222a. Display area 222c, in a further embodiment, may also be employed to display an aggregation of phonemic symbols as combined via the phonemic aggregation module 112.

The sample term display module 224, in the illustrated embodiment, displays sample words that each include a phonemic segment corresponding to the selected phonemic symbol. For example, portions of the sample German words illustrated, “östlich,” “Hölle,” and “möchte,” correspond to the phonemic segment represented by the phonemic symbol “œ.” In a given embodiment, the visual and audible representations, communicated via the video communication module 114 and audio communication module 110, may communicate an articulation of the sample terms.

The technical term display module 226 depicted includes German and English terms that linguistically describe the manner of articulation of the selected phonemic segment. For example, the phonemic segment corresponding to the phonemic symbol “œ” may be described in the English language by linguistic terms such as “middle,” “front,” “short,” “lax,” and “rounded.”

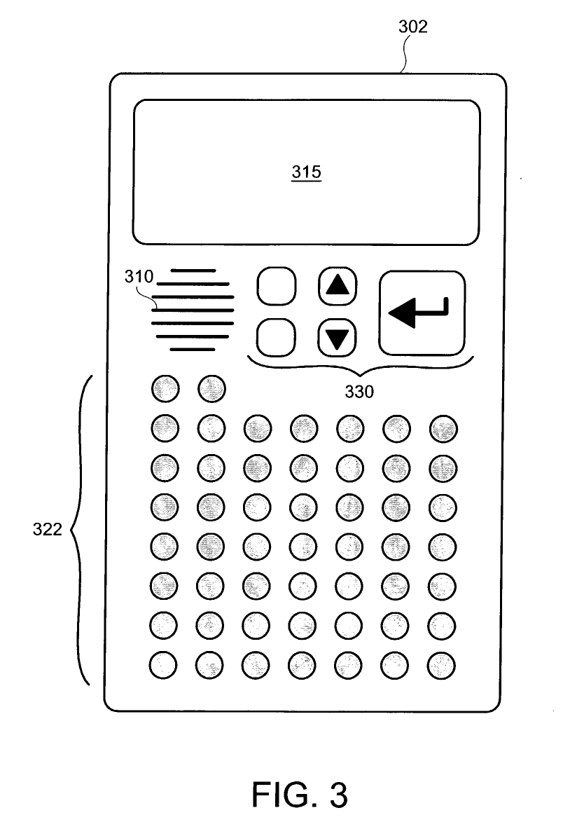

FIG. 3 depicts one embodiment of a portable apparatus 302 for phonetic dictation and instruction given by way of example of the apparatus 102 of FIG. 1. The depicted embodiment illustrates some of the externally viewable properties of the apparatus 102.

The apparatus 302 includes an audio communication module 310 in the form of an audio speaker. The apparatus 302 also includes a user interface screen 315 that may be used in conjunction with a variable display module 116 or a video communication module 114. A set of physical buttons, similar to buttons on a mathematical calculator, is used as part of the phonemic display module 322 as well as the phonemic selection module 108. Each button may have a phonemic symbol (not shown) printed or represented on the button or next to the button. Using the phonemic symbols, a user may depress the appropriate button to select a desired phonemic segment.

When a phonemic symbol button is depressed, the apparatus 302 may access a data memory, similar to the memory 106 of FIG. 1, and output an audible representation of the corresponding phonemic segment. Additionally, various textual and visual representations, as described above, may be communicated to a user via the user interface screen 315. These representations may display sample terms, technical terms, selected phonemic terms, articulation videos, etc. as programmed into the apparatus 302.

The illustrated portable apparatus 302 also includes a set of user interface buttons 330 that allow a user, in one embodiment, make selections regarding the user interface of the apparatus 302. For example, a user may use the interface buttons 330 to select a user language, adjust audio output volume, control video playback, or other similar functions appropriate to the apparatus 302.

One having skill in the art will recognize other physical implementations of the apparatus 302 consistent with the intent and functionality as described in the foregoing figures. For example, a portable apparatus 302 may be embodied in a personal digital assistant (PDA), in which the user interface 315 may be a touchscreen used as a medium for user input as well as a medium for visual output. Other aesthetics and functions may be added to our withheld from the depicted apparatus 302 without substantial deviation from the intent of the present invention.

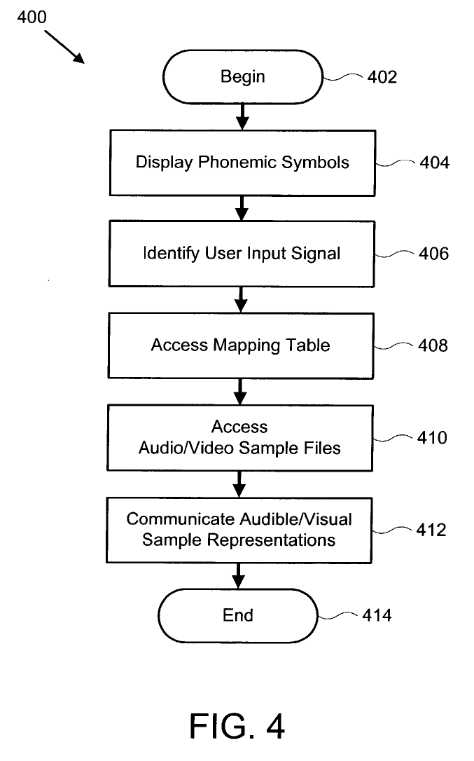

FIG. 4 depicts one embodiment of a representative process 400 for phonetic dictation and instruction. Specifically, the process 400 represents the functionality of, in one embodiment, the apparatus 102. The process 400 begins 402 by displaying 404 a set of phonemic symbols. This may be done, for example, via the phonemic symbol display module 108. The phonemic symbols may be displayed as digital representations, printed representations, or in another appropriate form. The process 400 then identifies 406 a user input signal designating a phonemic segment corresponding to the selected phonemic symbol. For example, the input signal may correspond to the digital identifier, such as a pointer to a video or audio file, discussed in conjunction with FIG. 1.

Using the digital identifier, the process 400 accesses 408, in one embodiment, a mapping table that defines a relationship between the designated phonemic segment, an audio file, a video file, or a phonemic symbol file. The mapping table may be stored in the memory 106 or on other suitable electronic storage media. The process 400 then accesses 410 the corresponding files and data as required to communicate 412 the audible and visual representations to a user, display sample terms, display technical terms, and any other appropriate representations described above or otherwise. Such communication to the user may be facilitated via the audio communication module 110, the video communication module 114, the variable display module 116, and so forth.

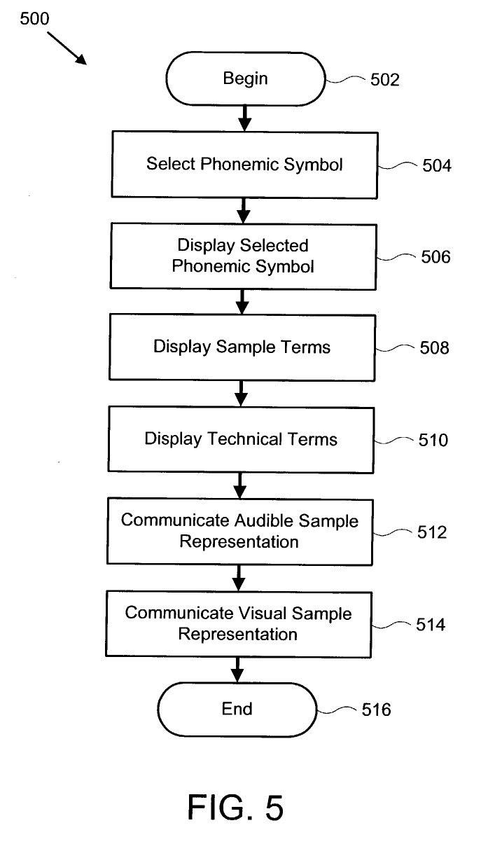

FIG. 5 depicts one embodiment of a process 500 for phonetic dictation and instruction from the perspective of a user of the apparatus 102. The process begins 502 as the user selects 502 a phonemic symbol displayed via the variable display module 116 and the phonemic selection module 108. The process 500 then displays 506 a representation of the selected phonemic symbol to the user through, for example, the phonemic symbol display module 122. Similarly, the process 500 displays 508, 510 the sample terms and technical terms to the user through, for example, the sample term display module 124 and the technical term display module 126, respectively.

The process 500 continues by communicating 512 the corresponding audible representation to the user. In one embodiment, the digital audio signal may be obtained from the memory 106 and communicated 512 via an internal electrical speaker, such as the audio speaker 310 of FIG. 3. The process 500 also communicates 514 the speaker demo and the point of articulation representations using, for example, the speaker demo module 118 and the point of articulation module 120, respectively, in the video communication module 114.

The process 500, in one embodiment, communicates 512, 514 the audible and visual representation synchronously to the user. Alternately, the audible and visual representations may be communicated 512, 514 asynchronously. In fact, one skilled in the art will recognize that one or more of the steps 506, 508, 510, 512, 514 may be executed independent of or in combination with each other in a number of ways so as to match any setup requirements of a particular user or to correspond to the complexity of a host apparatus or device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A process for phonetic dictation using an electronic device, the process comprising:
displaying a plurality of phonemic symbols corresponding to a plurality of International Phonetic Association (IPA) symbols;
selecting one of the plurality of displayed phonemic symbols; and
communicating an audible representation of a phonemic segment associated with the selected phonemic symbol.

2. The process of claim 1, further comprising communicating a visual representation of a human speaker articulating the phonemic segment associated with the selected phonemic symbol.

3. The process of claim 1, further comprising communicating a visual representation of a sectional view of a body part of a human speaker articulating the phonemic segment associated with the selected phonemic symbol.

4. The process of claim 1, further comprising displaying a sample textual representation that, when articulated, generates an audible representation of the phonemic segment associated with the selected phonemic symbol.

5. The process of claim 1, further comprising displaying a term of art associated with the study of phonetics and associated with articulation of the phonemic segment associated with the selected phonemic symbol.

6. The process of claim 1, further comprising aggregating a plurality of displayed phonemic symbols in an order determined by a user and communicating a representation of an articulation of the phonemic segments associated with the aggregated phonemic symbols.

7. The process of claim 1, further comprising displaying the plurality of phonemic symbols in an arrangement that conveys a relative location of articulation for each of the plurality of phonemic symbols.

8. A process for phonetic dictation using an electronic device, the process comprising:
displaying a plurality of phonemic symbols corresponding to a plurality of International Phonetic Association (IPA) symbols;
selecting one of the plurality of displayed phonemic symbols;
communicating an audible representation of a phonemic segment associated with the selected phonemic symbol;
communicating a visual representation of a human speaker articulating the phonemic segment associated with the selected phonemic symbol;
communicating a visual representation of a sectional view of a body part of a human speaker articulating the phonemic segment associated with the selected phonemic symbol;
displaying a sample textual representation that, when articulated, generates an audible representation of the phonemic segment associated with the selected phonemic symbol;
displaying a term of art associated with the study of phonetics and associated with articulation of the phonemic segment associated with the selected phonemic symbol; and
aggregating a plurality of displayed phonemic symbols in an order determined by a user and communicating a representation of an articulation of the phonemic segments associated with the aggregated phonemic symbols.

9. An apparatus for phonetic dictation within an electronic device, the apparatus comprising:
a variable display module including a phonemic symbol display module configured to display a plurality of phonemic symbols corresponding to a plurality of International Phonetic Association (IPA) symbols;
a phonemic selection module configured to allow selection of one of the plurality of displayed phonemic symbols; and
an audio communication module configured to communicate an audible representation of a phonemic segment associated with the selected phonemic symbol.

10. The apparatus of claim 9, further comprising a video communication module including a speaker demo module configured to communicate a visual representation of a human speaker articulating the phonemic segment associated with the selected phonemic symbol.

11. The apparatus of claim 9, further comprising a video communication module including a point of articulation module configured to communicate a visual representation of a sectional view of a body part of a human speaker articulating the phonemic segment associated with the selected phonemic symbol.

12. The apparatus of claim 9, wherein the variable display module further comprises a sample term display module configured to display a sample textual representation that, when articulated, generates an audible representation of the phonemic segment associated with the selected phonemic symbol.

13. The apparatus of claim 9, wherein the variable display module further comprises a technical term display module configured to display a term of art associated with the study of phonetics and associated with articulation of the phonemic segment associated with the selected phonemic symbol.

14. The apparatus of claim 9, further comprising a phonemic aggregation module configured to aggregate a plurality of displayed phonemic symbols in an order determined by a user and communicate a representation of an articulation of the phonemic segments associated with the aggregated phonemic symbols.

15. The apparatus of claim 9, wherein the phonemic symbol display module is further configured to display the plurality of phonemic symbols in an arrangement that conveys a relative location of articulation for each of the plurality of phonemic symbols.

16. An apparatus for phonetic dictation within an electronic device, the apparatus comprising:
a central processing unit configured to process electronic signals;
an electronic storage device configured to store computer readable code;
a variable display module including a phonemic symbol display module configured to display a plurality of phonemic symbols corresponding to a plurality of International Phonetic Association (IPA) symbols;
a phonemic selection module configured to allow selection of one of the plurality of displayed phonemic symbols;
an audio communication module configured to communicate an audible representation of a phonemic segment associated with the selected phonemic symbol;
a video communication module including:
a speaker demo module configured to communicate a visual representation of a human speaker articulating the phonemic segment associated with the selected phonemic symbol;
a point of articulation module configured to communicate a visual representation of a sectional view of a body part of a human speaker articulating the phonemic segment associated with the selected phonemic symbol;
a sample term display module, within the variable display module, configured to display a sample textual representation that, when articulated, generates an audible representation of the phonemic segment associated with the selected phonemic symbol;
a technical term display module, within the variable display module, configured to display a term of art associated with the study of phonetics and associated with articulation of the phonemic segment associated with the selected phonemic symbol; and
a phonemic aggregation module configured to aggregate a plurality of displayed phonemic symbols in an order determined by a user and communicate a representation of an articulation of the phonemic segments associated with the aggregated phonemic symbols.

17. A computer readable storage medium comprising computer readable code configured to carry out a process for phonetic dictation using an electronic device, the process comprising:
displaying a plurality of phonemic symbols corresponding to a plurality of International Phonetic Association (IPA) symbols;
selecting one of the plurality of displayed phonemic symbols; and
communicating an audible representation of a phonemic segment associated with the selected phonemic symbol.

18. The computer readable storage medium of claim 17, wherein the process further comprises communicating a visual representation of a human speaker articulating the phonemic segment associated with the selected phonemic symbol.

19. The computer readable storage medium of claim 17, wherein the process further comprises communicating a visual representation of a sectional view of a body part of a human speaker articulating the phonemic segment associated with the selected phonemic symbol.

20. The computer readable storage medium of claim 17, wherein the process further comprises displaying a sample textual representation that, when articulated, generates an audible representation of the phonemic segment associated with the selected phonemic symbol.

21. The computer readable storage medium of claim 17, wherein the process further comprises communicating a representation of an articulation of a plurality of phonemic segments that are arranged according to an order determined by a user.

22. A computer readable storage medium comprising computer readable code configured to carry out a process for phonetic dictation using an electronic device, the process comprising:
displaying a plurality of phonemic symbols corresponding to a plurality of International Phonetic Association (IPA) symbols;
selecting one of the plurality of displayed phonemic symbols;
communicating an audible representation of a phonemic segment associated with the selected phonemic symbol;
communicating a visual representation of a human speaker articulating the phonemic segment associated with the selected phonemic symbol;
communicating a visual representation of a sectional view of a body part of a human speaker articulating the phonemic segment associated with the selected phonemic symbol;
displaying a sample textual representation that, when articulated, generates an audible representation of the phonemic segment associated with the selected phonemic symbol;
displaying a term of art associated with the study of phonetics and associated with articulation of the phonemic segment associated with the selected phonemic symbol; and
aggregating a plurality of displayed phonemic symbols in an order determined by a user and communicating a representation of an articulation of the phonemic segments associated with the aggregated phonemic symbols.
